(19) United States
(12) Patent Application Publication
(10) Pub. No.: US 2003/0165237 A1
(43) Pub. Date: Sep. 4, 2003

(54) Integrated headset for any two-way-communication device

(76) Inventors: Alexander Farr, San Francisco, CA (US); RAY FARMANESH, SAN FRANCISCO, CA (US)

Correspondence Address: GREENBERG & LIEBERMAN, 314 PHILADELPHIA AVE., TAKOMA PARK, MD, 20912, US

(21) Appl. No.: 10/064,952

(22) Filed: Sep. 3, 2002

Related U.S. Application Data
(60) Provisional application No. 60/319,112, filed on Feb. 13, 2002.

(51) Int. Cl. H04M 1/00; H04M 9/00

(52) U.S. Cl. 379/430

(57) ABSTRACT

A head set device that is incorporated into a hand held electronic device such as a cellular phone, or portable digital assistant. The headset is manufactured with an earpiece for receiving sound, and a microphone for transmitting sound. In the electronic device are an indentation for storage of the earpiece and microphone, and a lock switch for securing the earpiece and microphone in the electronic device while not in use. The headset also has a retractable cord to extend the earpiece and microphone from the hand held device to place the earpiece in the ear canal. In another embodiment of the present invention the earpiece and microphone can function on a wireless transmitter, removing the need for the retractable cord.

### CROSS REFERENCE TO RELATED APPLICATIONS

Priority is hereby claimed Provisional Application, Serial No. 60/319,112, filed on Feb. 13, 2002, entitled INTEGRATED HEADSET FOR ANY TWO-WAY-COMMUNICATION DEVICE, in the name of Alexander Farr.

### BACKGROUND OF INVENTION

The present invention is an integrated headset device (either wired or wireless) for use with cellular phones, personal digital assistants, laptop computers, and any two-way-communication device and the like. More specifically, the present invention allows an alternative mode of operation in addition to such device's normal mode of operation.

Cellular phones, PDAs (personal digital assistants), and two-way communication devices have become tools of efficiency for many businessmen and women. These devices allow the businessperson to stay in contact with important business contacts or with their office while they are in transit from one meeting to another. Additionally many people use these devices to contact their family and friends while on the go. More recently PDAs have been adapted to incorporate cellular phone technology, or to have voice functions to transmit two way communication.

Often, operating a cellular phone to dial or talk to a contact can impede driving. Additionally in the advance of cellular technology including voice activation for calling, the user can have hands free calls. However in use of the hands free technology the caller must use the speaker phone technology inherent in the cellular phone, which can be of a lesser quality than use with the output of the phone during normal usage.

Therefore a head set is often need for comfort and convenience while calling.

Existent today are headset attachments for cellular phones. There are headset systems that are attached to a spool mechanism separate from the cellular phone. The majority of these systems require the user to manually wind the cable on the spool when the call is completed. There are a few retractable headsets available on the market, which retract, as a vacuum cleaner power cord, into a spool. The inherent problem with each of these headset devices is that they require the spool as a separate piece from the cellular phone. This spool can be easily lost, and requires the user to handle an additional piece of equipment in order to operate the cellular phone and head set.

U.S. Pat. No. 5,613,222 issued to Guenther on Mar. 18, 1997 shows a cellular telephone headset for hand-free communication. Guenther”s invention is unlike the present invention because it does not have a wireless function, the cord is not automatically retractable, and it has a separate transmitter for transmitting the sound through the cellular phone.

U.S. Pat. No. 5,719,935 issued to Ma, et al., on Feb. 17, 1998 shows a cellular telephone. Ma”s invention is unlike the present invention because it does not have an detachable ear piece with or without a retractable cord, and it requires the user to hold the cellular phone to their ear in order to hear or transmit sound.

Japanese Patent application no. 10,126,475 issued to Seymour on May 15, 1998 shows a handset. Seymour is unlike the present invention because it has a wrist attachment that requires the user to wrap the headset around the wrist and hold the wrist close to the ear to use the head set.

PCT application no. 9,844,762 submitted by Taenzer, et al., on Oct. 8, 1998 shows a wireless open ear canal earpiece. Taenzer”s invention is unlike the present invention because it has a tube that must be inserted into the ear canal to function, it does not disclose a means of use for a non-wireless connection and it does not describe an enclosure in the cellular phone which can hold the earpiece when not in use.

PCT application no. 0,005,924 submitted to Buchele, et al., on Feb. 3, 2000 shows a two-way communication earpiece. Buchele”s invention is unlike the present invention because it does not describe an enclosure in the cellular telephone or other device to enclose the earpiece, and it does not describe a means for a wired earpiece as well as the wireless means.

PCT application no. 0,068,131 submitted by Bruce, et al., on Nov. 16, 2000 shows a retractable cord device. Bruce”s invention is unlike the present invention because it is an external attachment to a cellular phone, the retractable mechanism is an external attachment to the phone, and it does not have a means for the ear piece to be used in a wireless fashion.

PCT application no. 0,128,195 submitted on Apr. 19, 2001 shows a cellular telephone, personal digital assistant, and pager unit with capability of short range radio frequency transmissions. This invention is unlike the present invention because it does not describe an enclosure in the cellular phone. PDA, or pager for the earpiece, and it includes a bone and audio sensor for use in the ear canal.

Therefore a need has been established for a cellular phone, or PDA with integrated head set technology.

### SUMMARY OF INVENTION

The present invention is an integrated head set and microphone for use with cellular phones, PDAs (personal digital assistants), two way communication devices, and personal organizers with sound capabilities. The headset is attached to the side plate of the cellular phone or other devices through a series of indentations shaped to fit the earpiece and microphone. The cord, in the wired mode, is enclosed in the interior of the phone and retracts when the head set is no longer in use. There is a lock switch located near the head set piece, which allows the user to lock the head set in the phone for storage. When the user pushes the head set out of its indentation space, the headset is activated for use. The integrated headset system snaps into the indentation for a seamless accessory to the phone. The user may use the phone in a conventional manner or by removing the headset from the housing, activate the headset and use the phone through the headset.

In the wired mode of the present invention the headset is extracted via a spool system and the lock switch will keep the chord locked in its extracted position. When finished with the call, the user can unlock the lock switch and the cord will automatically retract back into the phone housing, and the phone can be used in a conventional manner. In a wireless design the headset is released from the housing and simultaneously activated. By snapping the headset back into its housing the phone can be used in its conventional manner.

The head set is a small earpiece that fits into the user's ear canal and does not require a headband for use. Below the earpiece is a small microphone consistent with existing technology, to transmit the voice of the head set wearer through the cellular phone or PDA. The cord retracts into the side plate of the phone using a mechanism as is found in some vacuum cleaner power cords or hair dryer power cords. The head set is deactivated as the earpiece is snapped into place on the side of the phone.

The benefits of having an integrated headset for two-way communication devices using technology such as cellular or satellite such as cell phones, PDA's, two-way communicators, laptops, personal computers, and the like are as follows: convenience, ease of use, availability of alternative mode use, privacy, safely, added value, product differentiation, integrated headset is in addition to any standard or optional feature already available on device, headset availability always without carrying an additional accessory.

### BRIEF DESCRIPTION OF DRAWINGS

FIG. 1 shows a frontal view of the cellular phone with the headset extended. FIG. 2 shows a frontal view of the cellular phone with the headset retracted. FIG. 3 shows a picture of the PDA with the headset extended.

FIG. 4 shows the PDA device with the headset retracted.

FIG. 5 shows a two-way communicator device with the headset extended.

FIG. 6 shows a two-way communicator device with the headset retracted.

FIG. 7 shows a wireless version of the earpiece and microphone.

### DETAILED DESCRIPTION

The present invention is a headset integrated into a piece of electronics such as a cellular phone or a Personal Digital Assistant (PDA). There is a lock switch and a series of indentations intended to hold the earpiece and microphone when the headset is not in use. The cord for the headset retracts into the interior of the phone when not in use, and operates on an automatic retraction so the user does not have to wind the cord at the end of each call.

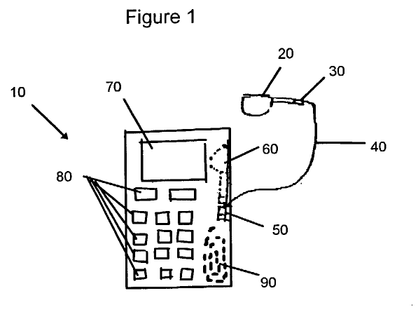

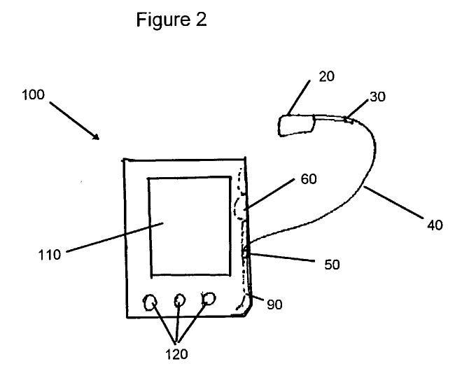

FIG. 1 shows a frontal view of the present invention (10) with the headset extended. The head set is manufactured with a small ear piece (20) which fits in the ear canal. The ear piece (20) is much like the bud ear phones for portable cassette radios, CD players, or MP3 units. Attached to the ear piece (20) is a retractable cord (40) that leads the ear piece (20) to the user's ear while in use, and when the user has finished their call the retractable cord automatically retracts into the phone into the storage space (90). On the retractable cord (40), below the ear piece (20) is a microphone (30) to receive the sound from the caller and transmit through the phone and digital network to the recipient of the call. Below the point that the retractable cord (40) enters the cellular phone there is a lock switch (50) to hold the ear piece (20) into the cellular phone. retractable cord (40) can, in other embodiments, be circular, square, or triangular in shape. The length of the retractable cord (40) is between 40 and 60 inches and the length can be adjusted to fit the device in which it is installed. The retractable cord (40) can also be altered to have the lock switch (50) hold the cord (40) in the fully extended position while in use, to prevent retraction of the cord (40) while the ear piece (20) and the microphone (30) are in use. In this embodiment, the retractable cord (40) would automatically retract into the storage space (90) when the lock switch (50) is released. A primary function of the storage space (90) and the indentation (60) are to allow the retractable cord (40), the ear piece (20), and the microphone (30) to fit seamlessly to the cellular phone, PDA or other electronic device. The storage space (90) can be placed in the device in any applicable space which will not interfere with the function of the device. In alternate embodiments of the present invention, the indentation (60), storage space (90), the retractable cord (40), ear piece (20), and the microphone (30) would be housed in a removable housing (not shown) that seamlessly attaches to a cellular phone, PDA or other electronic device in a modular design similar to a removable battery pack.

There is an indentation (60) in the side of the cellular phone to hold the ear piece (20) and microphone (30) when not in use. The ear piece (20) and microphone (30) are deactivated as soon as they are locked via the lock switch (50) into the indentation (60). The lock switch (50) is a lever that the user can depress with one finger to release the ear piece (20) and microphone (30). Also shown in FIG. 1, are the cellular display (70) and the control buttons (80) for the cellular phone. The display (70) and the control buttons (80) function in the manner conventional to cellular phones. FIG. 2 shows the cellular phone (10) with the ear piece (20) and microphone (30), retracted into the phone (10).

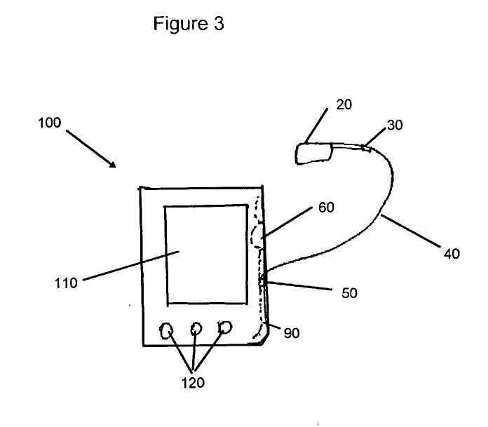

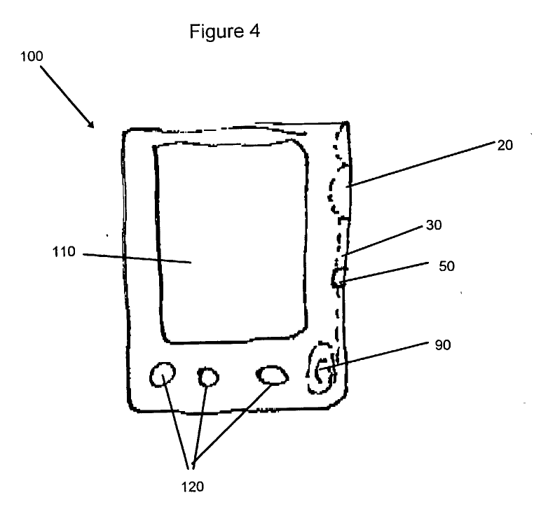

The preferred embodiment of the present invention includes the ear piece (20), the microphone (30), the lock switch (50) and indentation (60). The ear piece (20) can be a bud ear phone piece as in ear phones for CD players or portable cassette players., The ear piece (20), in alternate embodiments, can also be manufactured to have a curvature (not shown) as in some hearing aids to hold the ear piece in place. The curvature (not shown) would wrap around the top of the ear, behind the ear to fit close to the head, and would be removable. The curvature (not shown) would function in the same manner as the arms on a pair of sunglasses. The ear piece (20) can be manufactured as an ear bud piece for the comfort of the user. The ear piece (20) can be constructed of any strong and durable material, such as a hard plastic. The ear piece (20) if manufactured as a ear bud, would reduce the weight of the piece, and could have the microphone (30) attached to the ear piece (20) as in existing technology for headsets for cellular phones and the like. The ear piece (20) can be constructed of various materials as technology becomes more prevalent, and can be constructed of different materials to add strength to the ear piece (20). The microphone (30) in the wireless embodiment is extended below the ear piece (20) in a rigid fashion and fits securely in the indentation (60) when not in use. The microphone (30) in this embodiment functions in the same manner as the head sets used for two way radios, or the head set attachments used to replace the hand held receiver on land line phones. The microphone (30) in the wireless or wired embodiments is consistent with conventional design and texture, and can be of any feasible shape which can fit in an indentation (60). The ear piece (20) and microphone (30) are connected with semi-rigid wiring in all embodiments shown. A primary requirement of the ear piece (20) and the microphone (30) is their ability to fit in a seamless manner in the indentation (60). If necessary, in separate embodiments of the present invention, the ear piece, and microphone (30) can be constructed in the same housing for an easier fit to the indentation (60). The indentation (60) can be produced in any applicable shape, but is designed to best fit the workings of the cellular phone, PDA or other device without hindering function of the device. The indentation (60) is intended to fit the microphone (30) and ear piece (20) without disturbing the interior workings of the cellular phone, PDA or other applicable device. FIG. 3 shows the present invention in a PDA embodiment (100). The ear piece (20), microphone (30), retractable cord (40), lock switch (50), indentation (60) and storage space (90) of the head set function in the same manner as that of the first embodiment (FIG. 1, 10). The present embodiment (100) is a PDA with cellular technology included, but the head set technology (20,30,40,50,60) can be applied to any PDA device that emits sound, i.e. a PDA that also has MP3 or other music storage and playing capabilities. The PDA device (100) has a display (110) and control buttons (120) that function in the manner conventional to Portable Digital Assistants (PDA). FIG. 4 shows the PDA device (100) with the ear piece (20) and the microphone retracted into the PDA device (100).

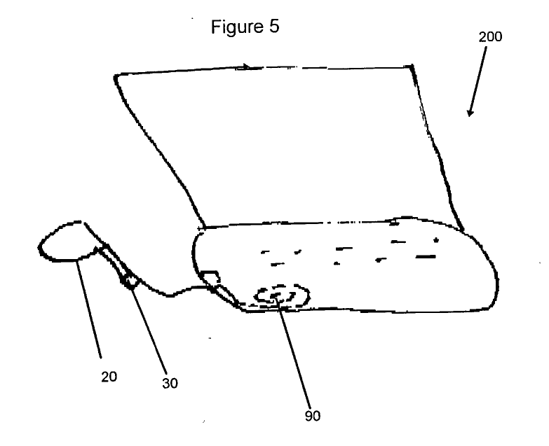

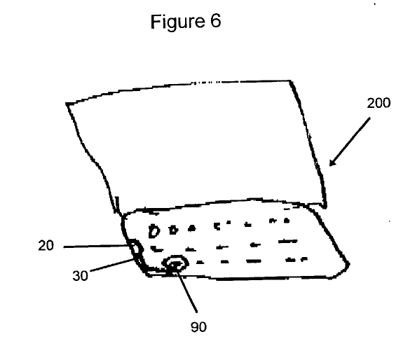

FIG. 5 shows the ear piece (20) and microphone (30) as attached to a two-way communicator device (200). The ear piece (20) and microphone (30) function in the same manner as described above for the cellular phone (10) and the PDA device (100). FIG. 6 shows the ear piece (20) and microphone (30) retracted into the indentation (as in FIG. 1, 60).

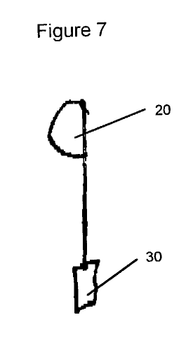

FIG. 7 shows the ear piece (20) and microphone (30) in a wireless format. The microphone in this embodiment functions as a transmitter to the cellular phone (10), PDA device (100) or two way communicator (200).

In summary the headset is essentially integrated, as it snaps into the housing to provide a seamless option/accessory.

The head set (20, 30, 40, 50, 60) can also be manufactured to fit a personal organizer, a portable MP3 player, or any hand held electronic device, and can be adapted to work in a wireless manner separate from these devices. The head set (20, 30, 40, 50, 60) in other embodiments, can be adapted to be modular in design and be in a removable section of the device, wherein if one piece of the head set (20, 30, 40, 50, 60) were to fail, the entire head set (20, 30, 40, 50, 60) could be easily replaced, similar to a removable battery pack. Whether the present invention (10) is corded or cordless, the design, and manufacturing can be changed to fit any applicable electronic device, and can be changed as the technology for these devices changes.

The present invention is not limited to the sole embodiments described above, but includes any and all embodiments of the following claims.

1. An integrated headset, comprising:
an earpiece;
a microphone communicating with said earpiece;
a cord, communicating with said earpiece, and said microphone;
a lock switch communicating with said earpiece and said microphone; and
an electronic device having an indentation for holding said earpiece and said microphone.

2. An integrated headset as in claim 1, wherein said cord is retractable into said electronic device.

3. An integrated headset as in claim 1, wherein said lock switch holds said earpiece, said microphone and said cord in said indentation of said electronic device.

4. An integrated headset as in claim 2, wherein said electronic device has an internal storage space for said cord.

5. An integrated headset as in claim 4, wherein said storage space is placed in said electronic device in such a way as to not interfere with the normal functions of said electronic device.

6. An integrated headset as in claim 1, wherein said lock switch holds said earpiece and said microphone to said electronic device.

7. An integrated headset as in claim 1, wherein said electronic device is a mobile telephone.

8. An integrated headset as in claim 1, wherein said electronic device is a personal digital device.

9. An integrated headset as in claim 1, wherein said electronic device is a portable MP3 player.

10. An integrated headset as in claim 1, wherein said electronic device is a two-way communicator device.

11. An integrated headset as in claim 1, wherein said electronic device is an portable calendar device.

12. An integrated wireless headset, comprising:
an earpiece;
a microphone communicating with said earpiece;
a lock switch communicating with said earpiece and said microphone; and
an electronic device having an indentation for holding said earpiece and said microphone.
